(19) United States
(12) Patent Application Publication
(10) Pub. No.: US 2026/0278688 A1
(43) Pub. Date: Sep. 17, 2026

(54) HARDWARE-ATTESTED WRAPPER FOR INSTITUTIONAL PREDICTION MARKETS

(71) Applicant: George William Bickerstaff, III, Greenwich, CT (US)

(72) Inventor: George William Bickerstaff, III, Greenwich, CT (US)

(21) Appl. No.: 19/679,828

(22) Filed: May 18, 2026

(51) Int. Cl. G06Q 40/06

(52) U.S. Cl. CPC G06Q 40/063

(57) ABSTRACT

A hardware-attested wrapper platform transforms a native prediction market contract into a wrapped derivative instrument within a hardware trusted execution environment having a hardware measurement register and a hardware-rooted attestation key. A compliance processing engine executes within the environment under a four-element interlock binding the measurement register to a measured compliance code base, sealing committed rule sets to the hardware identity, binding wrapped outputs to committed rule-set versions, and binding a compliance attestation record to the foregoing. The engine applies screening, jurisdictional mapping, Basel-aligned capital treatment, and regulatory reporting transformation. A compliance attestation record is admitted to an export interface only when the measurement register matches an authorized-measurement set and the record is signed by the hardware-rooted key within the environment. The record is independently verifiable against a hardware-vendor attestation service without operator participation.

### CROSS-REFERENCE TO RELATED APPLICATIONS

This application claims the benefit of priority under 35 U.S.C. § 119(e) and 37 C.F.R. § 1.78 to U.S. Provisional Patent Application No. 64/044,058, titled “REGULATORY-COMPLIANT WRAPPER FOR PREDICTION MARKET CONTRACTS IN INSTITUTIONAL FINANCIAL INFRASTRUCTURE,” filed Apr. 20, 2026 under USPTO Customer Number 212041, the entire disclosure of which is incorporated herein by reference for all purposes.

This application is further related to the following United States Provisional Patent Applications, each filed under USPTO Customer Number 212041 and each incorporated herein by reference in its entirety for all purposes including hardware trusted execution environment architectures, remote attestation primitives, trade surveillance, insider-risk flagging, and signal-weighted probability computations: (i) U.S. Provisional Patent Application No. 64/043,908, titled Hardware-Attested Trade Integrity System for Regulated Prediction Market Exchanges, filed on or about Apr. 19, 2026 (the “HATIS companion application”); (ii) U.S. Provisional Patent Application No. 64/044,023, titled Verified Prediction Confidence Scoring Engine for Signal-Weighted Probability Extraction in Regulated Prediction Market Exchanges, filed on or about Apr. 19, 2026 (the “VPCS companion application”); (iii) U.S. Provisional Patent Application No. 64/044,144, filed Apr. 20, 2026, Confirmation No. 2790 (the “FSO companion application”); and (iv) additional companion provisional applications filed in the same April 19 through Apr. 22, 2026 filing window covering related multi-exchange surveillance, fusion, and integrity functions. No claim of priority is made under 35 U.S.C. §§ 120 or 121 to any of the foregoing co-pending applications.

This application is further related to, and incorporates by reference in its entirety, the portfolio of applications filed under USPTO Customer Number 212041, including without limitation U.S. patent application Ser. Nos. 19/305,912, 19/307,191, 19/308,163, 19/309,743, 19/310,149, 19/377,771, 19/437,146, and 19/547,066, to the extent that said applications teach cryptographic attestation, federated governance, influence-graph analysis, and regulated-capital-markets compliance primitives applicable to the present subject matter.

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING APPENDIX

No nucleotide or amino acid sequences are disclosed herein. No table or computer program listing appendix is submitted with this application. The cryptographic specifications, algorithmic procedures, mathematical formulas, and data-structure schemas relied upon by the platform of the present invention are integrated into the body of this specification at the corresponding sections of the Detailed Description.

### FIELD OF THE INVENTION

The present invention relates to regulated financial instrument structuring, and more particularly to hardware-attested wrapper platforms and methods that transform native prediction market contracts into wrapped derivative instruments suitable for balance-sheet holding, intermediation, and reporting by prudentially regulated entities, by applying within a hardware trusted execution environment automated know-your-customer and anti-money-laundering screening, jurisdictional rule enforcement, position-limit controls, Basel-aligned capital treatment mapping, and standardized regulatory reporting transformation, and by producing cryptographically attested compliance outputs that are independently verifiable by regulators, supervisors, and institutional counterparties against a hardware-vendor attestation service.

### BACKGROUND OF THE INVENTION

### Regulatory Obligations of Institutional Participants

Prediction market exchanges have transitioned into regulated financial infrastructure. In July 2025, Polymarket acquired QCEX, comprising a Commodity Futures Trading Commission-registered derivatives exchange and clearinghouse. On Nov. 24, 2025, the Commodity Futures Trading Commission issued an Amended Order of Designation, announced publicly on Nov. 25, 2025, permitting operation as an intermediated Designated Contract Market under the Commodity Exchange Act and enabling futures-commission-merchant intermediation, traditional brokerage onboarding, and Part 16 regulatory reporting. Competing venues continue to scale event contracts across economic, political, and sports outcomes. Regulated status imposes compliance obligations substantially equivalent to those governing traditional derivatives markets. Institutional entities are subject to Basel capital frameworks, Commodity Futures Trading Commission reporting requirements under 17 C.F.R. Parts 16, 17, and 45, broker-dealer net capital rules under Securities Exchange Act Rule 15c3-1, and anti-money-laundering obligations under the Bank Secrecy Act.

### Limitations of Software-Only Compliance Processing

Manual compliance overlays and software-only compliance processing performed on exchange-operator-controlled infrastructure do not scale to institutional volumes and do not satisfy the supervisory documentation requirements of prudentially regulated counterparties. Such counterparties typically operate under model risk management frameworks that do not permit reliance on representations of an external operator, or of a software audit firm, as the sole basis for counterparty-level compliance documentation. Software-only compliance overlays operating on exchange-operator-controlled infrastructure cannot provide cryptographic assurance that the applied screening methodology, jurisdictional treatment mapping, capital methodology, and regulatory reporting records have not been altered, because the exchange operator retains the technical capability to modify any software-produced compliance record prior to disclosure.

### Absence of Integrated Hardware-Attested Wrapper Architecture

Trusted execution environment architectures providing hardware-rooted measurement, isolation, and remote attestation were developed primarily for confidentiality of private inputs in confidential-computing use cases, not for third-party verifiability of public compliance outputs. Generic hardware trusted execution environments attest the integrity of a measured code base; they do not produce a wrapped financial-instrument data structure cryptographically bound to specific versioned compliance rule sets, nor do they produce capital-treatment attributes and regulatory reporting records within a single hardware-rooted attestation envelope. Basel capital frameworks assume that the reporting institution performs and documents its own capital computation under its home-country supervisor's audit regime. Commodity Futures Trading Commission and Securities and Exchange Commission regulatory reporting tooling assumes operator-certified software-based report generation. No system known to the applicant integrates trusted-execution-environment isolation, hardware-anchored measurement of a compliance code base, hardware-sealed storage of committed compliance rule sets, and hardware-rooted cryptographic binding of wrapped instrument outputs to a compliance attestation record in a single architecture configured to transform native prediction market contracts into wrapped derivative instruments represented as versioned data structures suitable for institutional balance-sheet recognition, supervisory documentation, and regulatory reporting.

The combination of the foregoing deficiencies has the result that an institutional counterparty—such as a bank, broker-dealer, asset manager, clearinghouse, central bank, or sovereign wealth fund—cannot acquire, hold, intermediate, or report a prediction market position with cryptographic documentation that the applied screening methodology, jurisdictional treatment mapping, capital methodology, and regulatory reporting records were produced by an unaltered compliance code base operating under committed rule sets sealed to the hardware identity of the processing environment. Point solutions in the individually known categories of software-based compliance overlays, generic trusted-execution-environment confidential-computing tooling, capital-calculation libraries, and reporting-format converters do not combine to provide third-party verifiability of compliance integrity in a low-trust-operator context without intermediation by representations of the exchange operator or by software-audit-firm certifications.

### Prior-Art Distinction

Table 1 below sets forth, in tabular form, the technical distinctions between existing categories of compliance and confidential-computing infrastructure and the platform of the present invention. The table is illustrative and is provided for technical comparison only; no admission is made that any referenced category constitutes prior art against the claims appended hereto.

TABLE 1
Categorical distinction between the platform of the present invention and existing
categories of compliance and confidential-computing infrastructure.

| | | | Generic Trusted |
|---|---|---|---|
| | Existing Compliance | Exchange Reporting | Execution |
| Capability | Software | Systems | Environments |
| Hardware-anchored | Absent. Verification | Absent. Operator- | Present generically; not |
| measurement of | reduces to software | attested only. | bound to compliance |
| compliance code | audit certifications. | | code base or to |
| base | | | committed rule sets. |
| Hardware-sealed | Rule sets stored in | Operator-controlled; no | Sealing primitives exist |
| storage of | software-controlled | cryptographic binding | but not applied to |
| committed | storage; modifiable | to processing. | layered compliance rule |
| compliance rule sets | without hardware | | sets with version-bound |
| | detection. | | attestation. |
| Third-party- | Output binding limited | No cryptographic chain | Confidentiality |
| verifiable binding of | to operator signature or | to rule-set version. | protections only; not |
| wrapped outputs to | software audit | | designed for public |
| rule-set version | certification. | | verifiability of public |
| | | | outputs. |
| Integrated pipeline | Stages distributed | Reporting only; no | Provides a boundary but |
| (screening, | across operator software | integrated screening, | does not implement the |
| mapping, capital, | components without | mapping, or capital | integrated compliance |
| reporting) within a | unified attestation | pipeline. | pipeline. |
| single attestable | boundary. | | |
| boundary | | | |
| Federated | Absent. | Absent. | Not contemplated by |
| attestation with | | | general-purpose |
| companion trade- | | | confidential-computing |
| integrity and | | | frameworks. |
| probability systems | | | |
| Verifiability against | Verification requires | Verification requires | Available at the |
| hardware-vendor | reliance on operator or | reliance on operator | hardware level only; not |
| attestation service | third-party software | representations. | bound to compliance |
| without operator | auditor. | | outputs. |
| participation | | | |

### SUMMARY OF THE INVENTION

In plain terms, the invention enables institutional financial entities—banks, broker-dealers, hedge funds, asset managers, clearinghouses, central banks, and sovereign wealth funds—to use prediction market contracts by automatically wrapping each contract into a verifiable derivative instrument, while proving through hardware attestation that the correct compliance rules, input records, code base, and regulatory reporting methods were applied during the wrapping. The proof is independently verifiable by a regulator or institutional counterparty against the hardware vendor's attestation service, without participation of or reliance on representations by the prediction market exchange operator.

The present invention provides a hardware-attested wrapper platform, methods, and non-transitory computer-readable media for transforming native prediction market contracts into wrapped derivative instruments, each wrapped derivative instrument being represented within the platform as a versioned wrapped instrument definition data structure produced through hardware-anchored compliance processing whose outputs are cryptographically verifiable by regulators, supervisors, and institutional counterparties without reliance on representations of the prediction market exchange operator.

In one aspect, the platform comprises a hardware trusted execution environment having a hardware measurement register and a hardware-rooted attestation key, and a compliance processing engine executing within the hardware trusted execution environment, the compliance processing engine operating under a four-element interlock in which (i) the hardware measurement register cryptographically binds to a measured compliance code base loaded upon instantiation, (ii) committed compliance rule sets are sealed to a hardware identity of the hardware trusted execution environment, (iii) wrapped instrument outputs are bound to identifiers of the committed compliance rule sets in force during production, and (iv) a compliance attestation record cryptographically binds together the hardware measurement register, the input commitments, the committed rule-set commitments, and the wrapped instrument outputs. A compliance attestation record is admitted to an export interface only when a dual-gating condition is satisfied: (i) the hardware measurement register matches an authorized-measurement set committed at system initialization, and (ii) the compliance attestation record is signed using the hardware-rooted attestation key within the hardware trusted execution environment.

In a further aspect, the compliance processing engine comprises a screening module configured to apply automated know-your-customer, anti-money-laundering, sanctions, and eligibility screening against a committed rule set; a jurisdictional mapping module configured to transform the native prediction market contract into a wrapped instrument definition under a committed jurisdictional rule set; a capital treatment mapping module configured to assign Basel-aligned capital treatment attributes under a committed capital mapping methodology; a reporting transformation module configured to generate regulatory reporting records under a committed reporting schema mapping; and an attestation module configured to produce the compliance attestation record. The platform further comprises a companion-integration interface configured to receive attested inputs from companion hardware-attested trade integrity and probability systems, and a tamper-evident methodology ledger configured to receive only hardware-signed writes from the attestation module.

Outputs of the platform comprise a wrapped instrument definition, capital treatment attributes, regulatory reporting records, and a compliance attestation record, each produced within the hardware trusted execution environment and exported in a form independently verifiable against a hardware-vendor attestation service. The compliance attestation record binds the foregoing outputs to (i) the hardware measurement register value, (ii) cryptographic commitments over the ingested native contract specifications, position records, and participant-identity records, (iii) cryptographic commitments over the committed rule sets and methodology parameters in force during the production, and (iv) the wrapped instrument definition attributes, the assigned capital treatment attributes, and the regulatory reporting records. The foregoing summary is illustrative and is not intended to limit the scope of the claims appended hereto.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 and its subfigures FIG. 1A through FIG. 1E together depict the platform architecture;

FIG. 2 and its subfigures FIG. 2A through FIG. 2E depict the wrapping workflow;

FIG. 3 and its subfigures FIG. 3A through FIG. 3E depict the jurisdictional mapping decision flow;

FIG. 4 and its subfigures FIG. 4A through FIG. 4E depict the compliance attestation record structure; and

FIG. 5 and its subfigures FIG. 5A through FIG. 5E depict the institutional export and relying-party verification architecture. The following figures are referenced throughout the Detailed Description and are organized as set forth in Table 2 below.

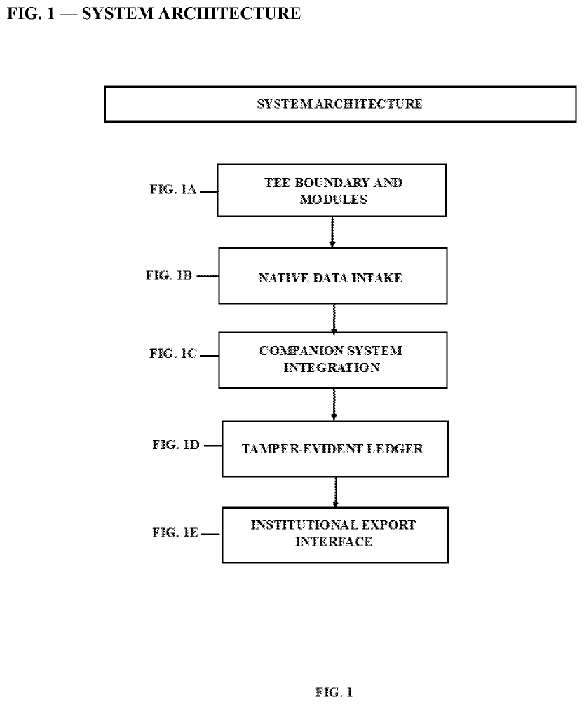

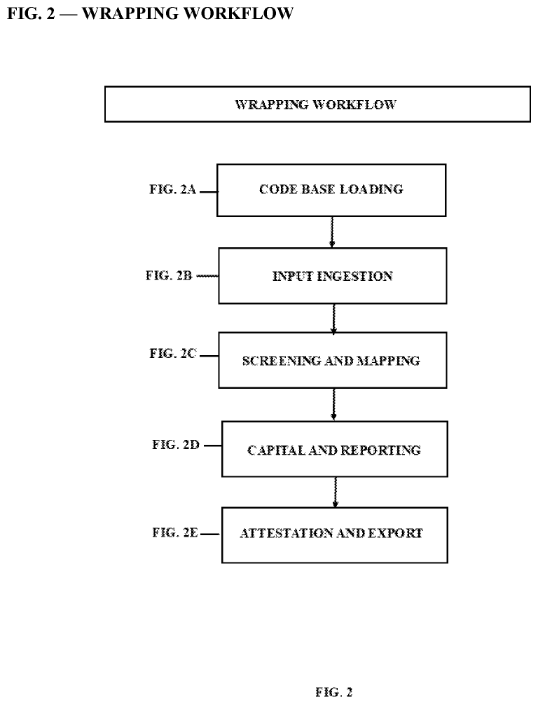

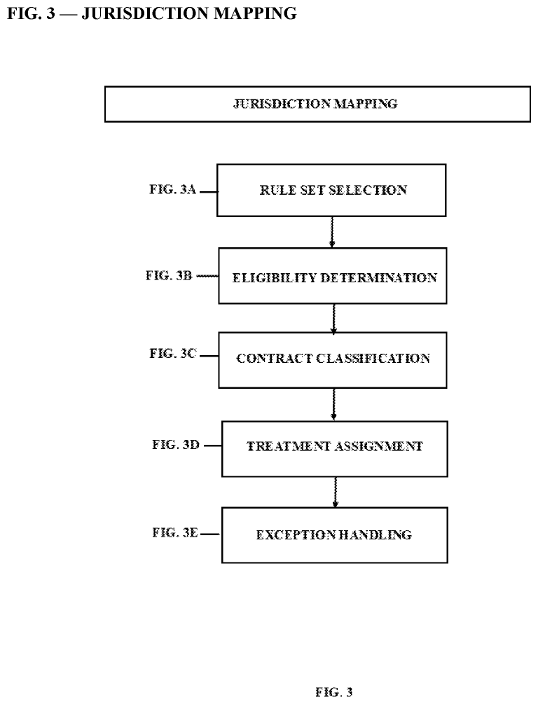

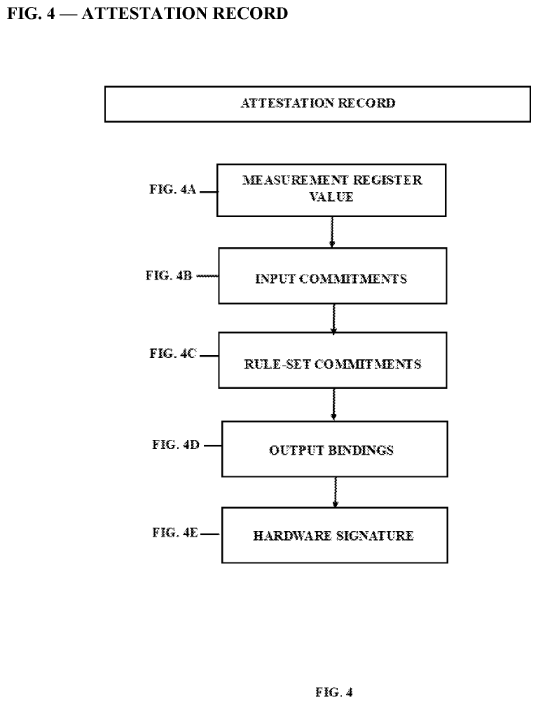

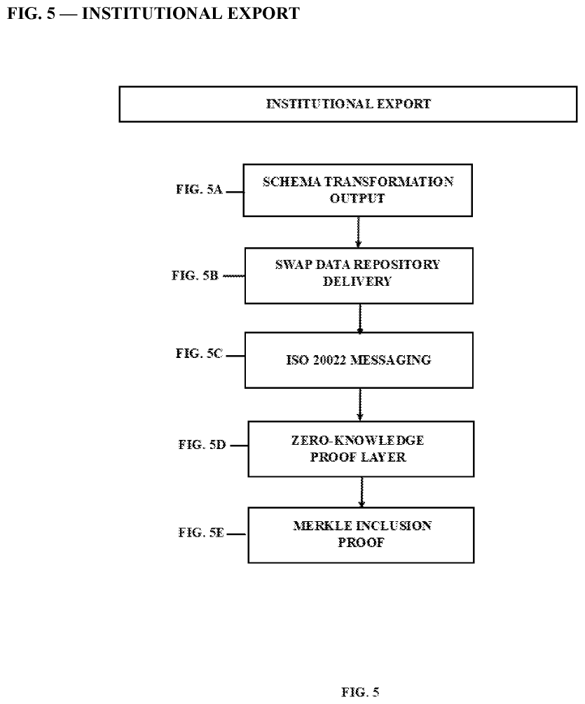

TABLE 2
Brief Description of the Drawings (parent figures and subfigures).

| FIG. | Title | Description |
|---|---|---|
| FIG. 1 | System Architecture | FIG. 1 is a block diagram of the hardware-attested wrapper |
| | | platform according to one embodiment. |
| FIG. 1A | TEE Boundary and | FIG. 1A depicts the trusted execution environment boundary |
| | Modules | enclosing the compliance processing engine and its |
| | | constituent modules. |
| FIG. 1B | Native Data Intake | FIG. 1B depicts the native data intake interface delivering |
| | | encrypted inputs to endpoints within the trusted execution |
| | | environment. |
| FIG. 1C | Companion System | FIG. 1C depicts the companion-integration interface receiving |
| | Integration | attested inputs from companion hardware-attested systems. |
| FIG. 1D | Tamper-Evident | FIG. 1D depicts the tamper-evident methodology ledger |
| | Ledger | receiving only hardware-signed writes. |
| FIG. 1E | Institutional Export | FIG. 1E depicts the institutional export interface delivering |
| | Interface | outputs to balance-sheet, repository, and audit systems. |
| FIG. 2 | Wrapping Workflow | FIG. 2 is a flow diagram illustrating one embodiment of the |
| | | method of producing a wrapped prediction market instrument. |
| FIG. 2A | Code Base Loading | FIG. 2A depicts loading of the measured compliance code |
| | | base into the trusted execution environment. |
| FIG. 2B | Input Ingestion | FIG. 2B depicts ingestion of native contract specifications, |
| | | position records, and participant-identity records. |
| FIG. 2C | Screening and | FIG. 2C depicts the screening and jurisdictional mapping |
| | Mapping | stages. |
| FIG. 2D | Capital and Reporting | FIG. 2D depicts the capital treatment mapping and reporting |
| | | transformation stages. |
| FIG. 2E | Attestation and | FIG. 2E depicts the production of a compliance attestation |
| | Export | record and its export. |
| FIG. 3 | Jurisdiction Mapping | FIG. 3 is a schematic diagram illustrating jurisdictional rule |
| | | mapping and instrument transformation. |
| FIG. 3A | Rule Set Selection | FIG. 3A depicts selection of a jurisdictional rule set from a |
| | | plurality of jurisdiction-specific rule sets. |
| FIG. 3B | Eligibility | FIG. 3B depicts the eligibility determination stage applied |
| | Determination | under the selected jurisdictional rule set. |
| FIG. 3C | Contract | FIG. 3C depicts the contract-type classification stage applied |
| | Classification | under the selected jurisdictional rule set. |
| FIG. 3D | Treatment Assignment | FIG. 3D depicts the treatment-attribute assignment stage of |
| | | the jurisdictional mapping module. |
| FIG. 3E | Exception Handling | FIG. 3E depicts the structured exception-handling pathways |
| | | triggered by ambiguity, ineligibility, or schema mismatch. |
| FIG. 4 | Attestation Record | FIG. 4 is a block diagram of the compliance attestation record |
| | | structure produced by the attestation module. |
| FIG. 4A | Measurement Register | FIG. 4A depicts the hardware measurement register value |
| | Value | field of the compliance attestation record. |
| FIG. 4B | Input Commitments | FIG. 4B depicts the cryptographic commitments over ingested |
| | | inputs included in the compliance attestation record. |
| FIG. 4C | Rule-Set | FIG. 4C depicts the cryptographic commitments over |
| | Commitments | committed rule sets and methodologies included in the record. |
| FIG. 4D | Output Bindings | FIG. 4D depicts the binding of the wrapped instrument |
| | | definition, capital treatment attributes, and reporting records |
| | | into the record. |
| FIG. 4E | Hardware Signature | FIG. 4E depicts the hardware-rooted attestation key signature |
| | | applied over the foregoing fields. |
| FIG. 5 | Institutional Export | FIG. 5 is a block diagram of the institutional export and |
| | | verification architecture. |
| FIG. 5A | Schema | FIG. 5A depicts the output of the reporting schema |
| | Transformation | transformation stage of the reporting transformation module. |
| | Output | |
| FIG. 5B | Swap Data Repository | FIG. 5B depicts delivery to a Commodity Futures Trading |
| | Delivery | Commission-designated Swap Data Repository. |
| FIG. 5C | ISO 20022 Messaging | FIG. 5C depicts delivery of compliance outputs through ISO |
| | | 20022-compliant messaging schemas. |
| FIG. 5D | Zero-Knowledge Proof | FIG. 5D depicts the optional zero-knowledge proof layer |
| | Layer | accompanying the compliance attestation record. |
| FIG. 5E | Merkle Inclusion | FIG. 5E depicts the relying-party verification path via Merkle |
| | Proof | inclusion proof against a published accumulator root. |

### DETAILED DESCRIPTION OF THE INVENTION

### Definitions

For purposes of this specification and the claims appended hereto, the following terms have the meanings set forth below. All definitions are intended to assist a person of ordinary skill in the relevant art in construing the disclosure and the claims, and apply consistently throughout this specification.

“alpha multiplier” a configurable, hardware-sealed numerical multiplier applied within a committed capital mapping methodology to a sum of replacement cost and potential future exposure to produce an exposure-at-default value, the value of the alpha multiplier being identified by an alpha-multiplier identifier committed to the compliance attestation record. In one embodiment, the alpha multiplier corresponds to the supervisory alpha set forth in the Standardized Approach for Counterparty Credit Risk.

“authorized-measurement set” a committed set of one or more hardware measurement register values authorized to perform attested compliance processing under this specification, the authorized-measurement set being established at system initialization and updatable only through an attested governance channel.

“committed capital mapping methodology” a versioned, sealed artifact identifying the formulas, parameters, and lookup tables by which replacement cost, asset-class add-ons, maturity adjustments, netting aggregation, and exposure-at-default are computed for a wrapped instrument definition, the version identifier of the committed capital mapping methodology being committed to the compliance attestation record.

“committed jurisdictional rule set” a versioned, sealed artifact identifying, for a given jurisdiction, eligibility determinations, permitted contract-type classifications, structuring parameters, margining and settlement attributes, and reporting-schema identifiers applicable to a native prediction market contract, the version identifier of the committed jurisdictional rule set being committed to the compliance attestation record.

“committed reporting schema mapping” a versioned, sealed artifact identifying, for each combination of wrapped-instrument treatment attributes and position-size thresholds, the applicable reporting schema, transformation function, and delivery endpoint, the version identifier of the committed reporting schema mapping being committed to the compliance attestation record.

“committed rule set” a versioned, sealed artifact comprising at least know-your-customer, anti-money-laundering, sanctions, and eligibility rules applied by the screening module to a participant-identity record, including configurable parameters α, β, γ, and δ (referenced herein as alpha, beta, gamma, and delta) that weight respective contributions of watchlist match, linkage fingerprint, unverified attestation, and insider-risk indicator, the parameter values being hardware-sealed under the version identifier of the committed rule set and identified to the compliance attestation record.

“companion hardware-attested system” a system operating in technical integration with the platform of the present invention, producing inputs that bear a companion attestation quote identifier cryptographically binding the inputs to the hardware identity of the companion system, including without limitation a companion hardware-attested trade integrity system and a companion verified prediction confidence scoring system.

“compliance attestation record” a cryptographically signed record produced within the hardware trusted execution environment that binds, at minimum, the hardware measurement register value, cryptographic commitments over ingested inputs, cryptographic commitments over the committed rule sets and methodologies in force, and the wrapped instrument definition together with assigned capital treatment attributes and generated regulatory reporting records, the binding being effected by a signature produced using the hardware-rooted attestation key.

“compliance processing engine” the execution context within the hardware trusted execution environment comprising the screening module, jurisdictional mapping module, capital treatment mapping module, reporting transformation module, and attestation module of this specification.

“dual-gating condition” a two-part admission condition under which a compliance attestation record is admitted to the export interface, the dual-gating condition being satisfied when (i) the hardware measurement register matches an authorized-measurement set committed at system initialization and (ii) a signature over the compliance attestation record is produced using the hardware-rooted attestation key within the hardware trusted execution environment.

“four-element interlock” the structural arrangement of the platform of the present invention in which (i) the hardware measurement register cryptographically binds to a measured compliance code base loaded upon instantiation, (ii) each committed rule set and committed methodology is sealed to a hardware identity of the hardware trusted execution environment, (iii) wrapped instrument outputs are bound to version identifiers of the committed rule sets and methodologies in force during production, and (iv) the compliance attestation record cryptographically binds together the hardware measurement register, the input commitments, the committed rule-set and methodology commitments, and the wrapped instrument outputs.

“hardware identity” a unique, hardware-vendor-issued identifier bound to a specific instance of a hardware trusted execution environment and used as a sealing key derivation input for sealed storage.

“hardware measurement register” a hardware-resident register whose value is generated by central processing unit microcode at instantiation of a measured code base, the value being a cryptographic hash of the loaded code base contents, such that any modification of the loaded code base produces a different register value upon a subsequent instantiation.

“hardware-rooted attestation key” a cryptographic key provisioned to a hardware trusted execution environment by the hardware vendor, usable only within the hardware boundary of said environment for the purpose of producing attestation quotes that chain to a hardware-vendor attestation service.

“hardware trusted execution environment” a hardware-enforced isolated execution context supported by a general-purpose processor or equivalent hardware, the integrity of whose contents is measurable by the hardware itself and attestable remotely through a cryptographic quote signed by a key rooted in the hardware, non-limiting examples including Intel Software Guard Extensions, Intel Trust Domain Extensions, Advanced Micro Devices Secure Encrypted Virtualization with Secure Nested Paging, Advanced Reduced Instruction Set Computer Machines Confidential Compute Architecture, and IBM Secure Execution for Linux.

“hardware-vendor attestation service” a service operated by the hardware vendor of the hardware trusted execution environment that verifies cryptographic attestation quotes produced by hardware instances against a hardware-vendor-issued chain-of-trust certificate.

“native prediction market contract” any instrument traded on a prediction market exchange whose payout is contingent on the occurrence or non-occurrence of a specified future event, including without limitation binary option contracts, categorical event contracts, scalar outcome contracts, and hybrid variants.

“participant-identity record” a pseudonymized record comprising at least one identifier derived from a cryptographic hash of know-your-customer attestation data, optionally accompanied by sanctions-screening signals and counterparty-linkage signals, the plaintext of said record not existing outside the hardware trusted execution environment during a computation interval.

“sealed storage” encrypted persistent storage accessible within the hardware trusted execution environment, the encryption key being derived from the hardware identity and an authorized-measurement set, such that the storage contents are readable only by compliance code whose measurement register value is present in the authorized-measurement set.

“supervisory factor” a configurable, hardware-sealed numerical factor identified for a given asset class within a supervisory factor table, the supervisory factor being multiplied with notional and a maturity factor to produce an asset-class add-on within a committed capital mapping methodology, and the supervisory factor table version being committed to the compliance attestation record.

“tamper-evident methodology ledger” an append-only ledger receiving only writes signed using the hardware-rooted attestation key from within the hardware trusted execution environment, organized as a Merkle accumulator whose root is periodically published to an external public commitment channel.

“wrapped derivative instrument” a derivative financial instrument derived from a native prediction market contract by application of a committed jurisdictional rule set within the hardware trusted execution environment, and represented within the platform of the present invention as a versioned wrapped instrument definition data structure, such that the data structure carries cryptographic bindings to the committed jurisdictional rule set version, the committed capital mapping methodology version, the committed reporting schema mapping version, the measured compliance code base, and the hardware measurement register sufficient for institutional balance-sheet recognition, supervisory documentation, and regulatory reporting. As used throughout this specification, the term identifies the regulatory-functional category of the derivative; the data-structure representation thereof is identified herein as the “wrapped instrument definition.”

“wrapped instrument definition” a versioned data record produced by the jurisdictional mapping module that specifies, for a wrapped derivative instrument derived from a native prediction market contract, the source identifiers, regulatory-designation attributes, contract-classification attributes, economic attributes, institutional-treatment attributes, reporting attributes, companion-system references, and attestation commitments sufficient for institutional balance-sheet recognition, supervisory documentation, and regulatory reporting.

### System Overview

FIG. 1 and the subfigures thereof depict, in block diagram form, a hardware-attested wrapper platform 100 according to one embodiment. The platform 100 comprises a hardware trusted execution environment 110 having a hardware measurement register and a hardware-rooted attestation key; a compliance processing engine 120 executing within the hardware trusted execution environment 110 and comprising a screening module 130, a jurisdictional mapping module 140, a capital treatment mapping module 150, a reporting transformation module 160, and an attestation module 170; a native data intake interface 115 delivering native contract specifications, position records, and participant-identity records into the hardware trusted execution environment 110 over encrypted channels terminating at endpoints within the hardware trusted execution environment 110; a companion-integration interface 125 receiving attested inputs from companion hardware-attested systems; a tamper-evident methodology ledger 180 receiving only hardware-signed writes from the attestation module 170; and an institutional export interface 190 delivering compliance outputs to institutional balance-sheet systems, regulatory reporting endpoints, and audit-trail facilities. The platform 100 may be deployed on single-tenant bare-metal servers with trusted-execution-environment-equipped processors, confidential-compute virtual machines offered by cloud infrastructure providers, or hybrid deployments combining on-premises trusted-execution-environment-equipped servers with cloud-hosted attestation-verification services.

The compliance code base executing within element 110 is measured by hardware upon instantiation, producing a measurement value that is incorporated into subsequent attestation quotes issued by the attestation module 170. Plaintext of participant-identity records, native contract specifications, and committed rule sets does not traverse any channel outside the hardware trusted execution environment 110. The platform 100 operates under the four-element interlock comprising (i) cryptographic binding of the hardware measurement register to the measured compliance code base loaded upon instantiation, (ii) sealing of the committed compliance rule sets to the hardware identity of the hardware trusted execution environment 110, (iii) binding of the wrapped instrument outputs produced by the compliance processing engine 120 to identifiers of the committed compliance rule sets in force during the production, and (iv) cryptographic binding of the compliance attestation record to the hardware measurement register, the input commitments, the committed rule-set commitments, and the wrapped instrument outputs. A compliance attestation record is admitted to the institutional export interface 190 only when the dual-gating condition is satisfied: (a) the hardware measurement register matches an authorized-measurement set committed at system initialization, and (b) the compliance attestation record bears a signature produced using the hardware-rooted attestation key within the hardware trusted execution environment 110.

With respect to hardware measurement register mechanics, the hardware measurement register of the hardware trusted execution environment 110 is populated by central processing unit microcode upon instantiation of the measured compliance code base. The microcode computes a cryptographic hash over the contents of the enclave memory representing the loaded compliance code base, including code segments, initialized data segments, and identified read-only segments, and writes the resulting hash value into the hardware measurement register. Any modification of the loaded compliance code base, including a single-bit change in a code segment, produces a different cryptographic hash and therefore a different hardware measurement register value upon a subsequent instantiation, providing hardware-level evidence of the precise code base under which a compliance attestation record was produced. The hardware measurement register value is included verbatim within the compliance attestation record and is independently verifiable against the hardware-vendor attestation service of the hardware vendor.

### Standard Computer Hardware Environment

The platform 100 may be embodied on conventional computer hardware comprising: one or more central processing units supporting the hardware trusted execution environment 110, including without limitation processors implementing Intel Software Guard Extensions, Intel Trust Domain Extensions, Advanced Micro Devices Secure Encrypted Virtualization with Secure Nested Paging, Advanced Reduced Instruction Set Computer Machines Confidential Compute Architecture, or IBM Secure Execution for Linux; encrypted random-access memory of sufficient capacity to hold the measured compliance code base and operative committed rule sets within the hardware trusted execution environment 110; non-volatile storage including without limitation NVM Express solid-state storage for sealed-store persistence; network interface controllers configured to terminate encrypted channels at endpoints within the hardware trusted execution environment 110; a system bus interconnecting the foregoing components; and a hardware security module operating in accordance with Federal Information Processing Standard 140-3 Level 3 or equivalent certification for ancillary key management. The foregoing hardware components are conventional and individually known in the art; the inventive aspects of the platform 100 reside in the architectural integration of the four-element interlock and the dual-gating condition recited herein, not in the individual hardware components.

### Inventive Technical Concept

The technical inventive concept of the platform 100 is the architectural integration of four cryptographic bindings that operate together as a unitary integrity guarantee, in combination with a dual-gating admission test that prevents export of compliance outputs absent satisfaction of both a hardware-state condition and a hardware-signed-output condition.

Generic hardware trusted execution environments support remote attestation of a measured code base. However, generic remote attestation does not extend to versioned compliance rule sets, does not produce a financial-instrument data structure as an output, and does not bind such an instrument data structure to specific rule-set version identifiers within the same attestation envelope. Generic confidential-computing tooling provides isolation primitives but is configured for confidentiality of private inputs in confidential-computing use cases, not for third-party verifiability of public compliance outputs. Generic compliance software supports field-level rule application against participant-identity records and instrument descriptions; however, generic compliance software operates outside of any hardware integrity boundary and produces outputs whose integrity reduces to operator representations or to software-audit certifications of a prior software state. Generic compliance software does not produce a financial-instrument data structure bound to cryptographic commitments over the rule set, methodology, and measurement state under which the data structure was produced.

The platform 100 of the present invention combines the foregoing categories into a single architecture in which (i) hardware-rooted code base measurement, (ii) sealed compliance rule sets, (iii) output binding to rule-set versions, and (iv) cryptographic enclosure of the output and bindings within a single attestation record operate as one integrated four-element interlock. The interlock is conditioned by a dual-gating admission test under which a compliance attestation record is admitted to the export interface 190 only when (a) the hardware measurement register matches an authorized-measurement set committed at system initialization and (b) the compliance attestation record is signed using the hardware-rooted attestation key within the hardware trusted execution environment 110. The combination is structurally distinct from the union of its component categories: neither a generic trusted execution environment alone, nor generic compliance software alone, nor the two operated in sequence without architectural integration, produces a wrapped financial-instrument data structure cryptographically bound to its rule-set provenance and to its measured compliance code base within a single hardware-rooted attestation envelope.

### Technical Effects Achieved by the Invention

The platform 100 achieves the following specific technical effects on the computer system on which it is embodied. Each technical effect constitutes an objective improvement in the functionality of the computer system and is realized through the architectural integration described in this specification, not by the individual hardware or software components operated in isolation or in unintegrated sequence.

First, the platform 100 produces compliance outputs whose integrity is verifiable by a relying party through cryptographic operations against a hardware-vendor attestation service, without intermediation by representations of the platform operator, the prediction market exchange operator, or a software-audit firm. This is a specific improvement in computer functionality: the computer system on which the platform 100 is embodied is configured to produce, as one of its computational outputs, evidence of its own computational integrity that is independently checkable by a third-party verification stack consisting solely of standard cryptographic primitives.

Second, the platform 100 eliminates the class of attacks in which a compliance code base is modified between attestation and computation, between computation and export, or between successive computations within the same nominal session. The hardware measurement register binds at instantiation to the measured compliance code base, and the dual-gating admission test requires the measurement register value present at export to match the authorized-measurement set; modification of the code base between any of these events produces a different measurement register value and prevents export.

Third, the platform 100 binds compliance outputs to specific versions of rule sets and methodologies in force during production, eliminating the class of historical-audit failures in which the rule set or methodology in force at the time of a past computation cannot be deterministically identified by a later relying party. The committed-version identifiers are committed to the compliance attestation record at production time and remain verifiable indefinitely against the tamper-evident methodology ledger 180.

Fourth, the platform 100 supports federated cross-system attestation through cryptographic incorporation of companion attestation quote identifiers into the compliance attestation record. A relying party verifying a compliance attestation record can traverse the companion quote identifiers to independently verify the integrity of upstream surveillance inputs, probability inputs, or other companion-system inputs, achieving a chain of cryptographic integrity across distributed compliance subsystems without recourse to operator representations at any node.

Fifth, the platform 100 supports cryptographic preservation of historical compliance records under rule-set updates, algorithm transitions, and rollback operations. Each governance event produces an attested record committed to the tamper-evident methodology ledger 180, and the chain of hash references from records produced under predecessor algorithm identifiers to records produced under successor algorithm identifiers preserves verifiability of the historical chain by a relying party at any future date, including under post-quantum cryptographic transitions.

Sixth, the platform 100 reduces the trust burden borne by a relying party performing verification of a compliance attestation record. The verification reduces to a small fixed number of cryptographic checks against (i) a hardware-vendor attestation service for the chain-of-trust certificate, (ii) the published governance root certificate for committed-version identifiers, and (iii) optionally the tamper-evident methodology ledger 180 for temporal-integrity proofs. The relying party does not maintain operator-trust relationships, audit-firm certifications, or other intermediation infrastructure for verification. This is a specific improvement in the functionality of the relying party's computer system: the relying party's verification stack scales sublinearly with the volume of compliance records being verified.

### Technical Problem and Technical Solution

The technical problem addressed by the platform 100 arises in the context of computer-implemented compliance processing for prediction market contracts. A prudentially regulated institutional counterparty subject to Basel capital frameworks, Commodity Futures Trading Commission reporting obligations, Securities and Exchange Commission net capital rules, or equivalent foreign prudential supervision cannot acquire, hold, intermediate, or report a prediction market position with cryptographic assurance, verifiable by a third party, that the applied compliance methodology, jurisdictional treatment mapping, capital methodology, and regulatory reporting records were produced by an unaltered compliance code base operating under committed compliance rule sets in force at the time of production. Software-only compliance overlays operating on operator-controlled infrastructure cannot provide this assurance because the operator retains technical capability to modify any software-produced compliance record prior to disclosure, and software audit certifications attesting to a prior software state do not provide cryptographic evidence of the state of the compliance code base or of the committed rule sets at the moment a specific compliance output was produced. Generic confidential-computing tooling can isolate and attest a compliance code base but does not, without further structural integration, bind the resulting attestation to specific compliance rule sets in force or to specific wrapped instrument outputs.

The platform of the present invention provides a technical solution that improves the functionality of the computer system on which the platform is embodied. The four-element interlock binds the hardware measurement register to the measured compliance code base, the committed compliance rule sets to the hardware identity, the wrapped instrument outputs to the committed rule-set versions, and the compliance attestation record to the foregoing elements. The dual-gating condition prevents export of a compliance attestation record absent both a verified hardware measurement register state and a hardware-rooted signature produced within the hardware trusted execution environment. The combination of the interlock and the gating provides cryptographic verifiability—by any relying party against the hardware-vendor attestation service—of compliance output integrity, rule-set integrity, and input-record integrity, a capability unobtainable by software-only compliance processing on a generic computer regardless of audit thoroughness. This capability is a specific improvement in computer functionality: the platform converts a class of compliance computations whose integrity was previously verifiable only through external software-audit certifications or operator representations into a class of compliance computations whose integrity is cryptographically verifiable by a third party without intermediation.

### Screening Module

The screening module 130 of FIG. 1A, executing within the hardware trusted execution environment 110, applies automated know-your-customer, anti-money-laundering, sanctions, and eligibility screening to participant-identity records under a committed rule set sealed to the hardware identity of the hardware trusted execution environment 110. The committed rule set comprises name and address matching parameters against watchlist and sanctions lists, graph-based linkage analysis parameters operative on linkage fingerprints received over the companion-integration interface 125, verification predicates for know-your-customer attestations produced by regulated futures-commission-merchants and broker-dealers, and composite-risk-score parameters comprising configurable weighting coefficients α (alpha), β (beta), γ (gamma), and δ (delta) referenced as committed rule-set parameters and identified to the compliance attestation record.

In one non-limiting embodiment, the screening module 130 computes a composite risk score as a weighted sum: a contribution proportional to a watchlist match score scaled by α, a contribution proportional to a linkage-fingerprint magnitude scaled by β, a contribution proportional to an unverified-attestation indicator scaled by γ, and a contribution proportional to an insider-risk indicator scaled by δ. The composite risk score is compared against committed hard-block and soft-flag thresholds. A composite risk score exceeding the hard-block threshold produces a disposition indicator of hard-block, halting wrapping and producing an attested exception record. A composite risk score exceeding the soft-flag threshold but not the hard-block threshold produces a disposition indicator of soft-flag, permitting wrapping with elevated capital treatment and enhanced reporting. A composite risk score below the soft-flag threshold produces a disposition indicator of pass. All dispositions are attested in the compliance attestation record produced for the corresponding computation interval.

### Jurisdictional Mapping Module

The jurisdictional mapping module 140 of FIG. 1A and FIG. 3, executing within the hardware trusted execution environment 110, maintains a plurality of jurisdiction-specific rule sets for at least United States Commodity Exchange Act-designated contract markets under Commodity Exchange Act Section 5; United States intermediated Designated Contract Markets permitting futures-commission-merchant intermediation; United States Securities and Exchange Commission-registered securities exchanges under the Securities Exchange Act of 1934; and equivalent foreign regulatory regimes. Each jurisdiction-specific rule set comprises eligibility determinations, permitted contract-type classifications, structuring parameters, margining and settlement attributes, and reporting-schema identifiers. The wrapped instrument definition produced by the jurisdictional mapping module 140 is a versioned data record whose field-level schema is committed to the compliance attestation record through a wrapper-schema version identifier.

With reference to FIG. 3A through FIG. 3E, the jurisdictional mapping flow proceeds by (i) selecting a jurisdiction-specific committed rule set based on the source-exchange identifier and the regulatory designation of the native prediction market contract, (ii) applying the eligibility determination of the selected rule set to the native prediction market contract, (iii) traversing a priority-ordered decision tree of the selected rule set to classify the native prediction market contract into a contract type and a treatment class, (iv) assigning treatment attributes including notional, settlement type and mechanism, margin requirements, position limits, and reporting-schema identifier under the selected rule set, and (v) raising a structured exception in cases of ineligibility, mapping ambiguity, or schema mismatch. Where more than one terminal rule applies and a deterministic precedence rule does not resolve the conflict, the jurisdictional mapping module 140 raises a mapping-ambiguity exception. The wrapped instrument definition produced by the jurisdictional mapping module 140 is committed to the compliance attestation record and is also bound by cross-reference to attestation quote identifiers of any companion hardware-attested systems whose inputs informed the mapping.

### Capital Treatment Mapping Module

The capital treatment mapping module 150 of FIG. 1A, executing within the hardware trusted execution environment 110, assigns institution-specific capital treatment attributes to each wrapped instrument definition under a committed capital mapping methodology. The committed capital mapping methodology is a versioned, sealed artifact identifying the formulas, parameters, and lookup tables by which replacement cost, asset-class add-ons, maturity adjustments, netting aggregation, and exposure-at-default are computed. In one non-limiting embodiment, the committed capital mapping methodology comprises the formulas and parameter set of the Standardized Approach for Counterparty Credit Risk as set forth in the relevant Basel Committee publication and as implemented under applicable United States federal banking agency capital rules or equivalent foreign prudential rules.

In one non-limiting embodiment, the capital treatment mapping module 150 computes, for each wrapped instrument definition: (i) a replacement cost as the maximum of zero and the current market value reduced by applicable collateral; (ii) an asset-class add-on as the product of a committed supervisory factor for the assigned asset class, an effective notional amount, and a committed maturity factor; (iii) a potential future exposure as the aggregate asset-class add-on adjusted by a committed netting multiplier where a qualified netting set applies; and (iv) an exposure-at-default value as the committed alpha multiplier applied to the sum of the replacement cost and the potential future exposure. The committed capital mapping methodology version, the committed supervisory factor table version, the committed alpha multiplier, and the committed netting determination are committed to the compliance attestation record.

Where a companion verified prediction confidence scoring system has delivered an attested probability record bearing an insider-risk indicator computed at a configured z-score threshold and a companion attestation quote identifier, the capital treatment mapping module 150 verifies the companion attestation quote against the hardware-vendor attestation service and, upon successful verification, applies a risk adjustment to the exposure-at-default value of the form EAD′=EAD·(1+δ·insider_risk_indicator), where δ is a committed rule-set parameter and the adjustment is bounded by a committed cap committed within the rule set. Upon failed verification of the companion attestation quote, the capital treatment mapping module 150 raises a companion-system-attestation-failure exception.

### Reporting Transformation Module

The reporting transformation module 160 of FIG. 1A and FIG. 5A, executing within the hardware trusted execution environment 110, automatically maps wrapped instrument definitions and associated position records to regulatory reporting records under a committed reporting schema mapping. The committed reporting schema mapping is a versioned, sealed artifact identifying, for each combination of wrapped-instrument treatment attributes and position-size thresholds, the applicable reporting schema, transformation function, and delivery endpoint. In one non-limiting embodiment, the committed reporting schema mapping is configured to support submission under 17 C.F.R. Part 16 for wrapped instruments whose treatment attributes classify them as contracts traded on a Designated Contract Market; under 17 C.F.R. Part 17 for positions exceeding applicable large-trader thresholds identified in the committed reporting schema mapping; under 17 C.F.R. Part 45 for wrapped instruments whose treatment attributes classify them as swaps under the committed jurisdictional rule set, with delivery configured to support submission to a Commodity Futures Trading Commission-designated Swap Data Repository; and under equivalent foreign regulatory schemas where applicable.

Field-level transformation from a wrapped instrument definition to a reporting record under a given reporting schema proceeds through the committed reporting schema mapping by an attested schema-transformation procedure. For each reporting-record field, the committed reporting schema mapping identifies (i) the source field or fields in the wrapped instrument definition, (ii) the transformation function applied (identity, type cast, enumeration remapping, unit conversion, derivation formula), (iii) any committed constants or parameters consumed by the transformation function, and (iv) a validity predicate applied to the transformed value. The transformation procedure enforces the validity predicate within the hardware trusted execution environment 110 prior to emission of the reporting record; failures produce a reporting-schema-mismatch exception. For each produced reporting record, the reporting transformation module 160 emits a companion schema-transformation log comprising, for each field, the source-field identifier, the transformation function identifier, and a cryptographic hash of the transformed value, the schema-transformation log being committed to the compliance attestation record.

### Attestation Module

The attestation module 170 of FIG. 1A and FIG. 4, executing within the hardware trusted execution environment 110, produces compliance attestation records on an event-driven basis following each production of a wrapped instrument definition and capital treatment assignment. With reference to FIG. 4A through FIG. 4E, each compliance attestation record binds together: (i) the value of the hardware measurement register as populated by central processing unit microcode upon instantiation of the measured compliance code base; (ii) a hardware-vendor-signed chain-of-trust certificate bound to the hardware identity of the hardware trusted execution environment 110; (iii) a cryptographic commitment over the ingested native prediction market contract specifications, position records, and participant-identity records; (iv) cryptographic commitments over the committed rule sets in force during the computation, including at least the committed-rule-set version identifier, the committed jurisdictional rule-set version, the committed supervisory factor table version, the committed alpha multiplier, the committed netting determination, and the committed reporting schema version; (v) the wrapped instrument definition attributes, the assigned capital treatment attributes, and the generated regulatory reporting records; (vi) attestation quote identifiers of each companion hardware-attested system whose attested input was consumed during the computation; and (vii) a signature over the foregoing fields produced using the hardware-rooted attestation key.

The compliance attestation record is produced in a format independently verifiable against the hardware-vendor attestation service of the hardware vendor. A relying party verifies the compliance attestation record by (a) retrieving the hardware-vendor-signed chain-of-trust certificate referenced in the record, (b) verifying that the hardware measurement register value in the record is consistent with the authorized-measurement set published or otherwise known to the relying party, (c) verifying the signature over the record against the hardware-rooted attestation key referenced in the chain-of-trust certificate, and (d) recomputing the cryptographic commitments over the ingested inputs and the committed rule sets from delivered evidence and confirming consistency with the commitments in the record. Where a companion attestation quote identifier is committed to the record, the relying party additionally retrieves and verifies the companion attestation quote against the hardware-vendor attestation service. Successful completion of the foregoing verification procedure confirms, without participation of or reliance on representations by the prediction market exchange operator, that the compliance attestation record was produced by the identified compliance code base under the identified committed rule sets and methodologies.

### Sealed Rule-Set Update Protocol

Each committed rule set and committed methodology of this specification is stored in sealed storage keyed to the hardware identity of the hardware trusted execution environment 110 and to a committed authorized-measurement set. Rule-set updates are delivered to the hardware trusted execution environment 110 through an attested governance channel. A proposed update is signed by an authorized update key whose certificate chains to a governance root certificate committed at system initialization. The update is wrapped in an update record comprising (i) an updating-authority identifier, (ii) an update timestamp, (iii) a prior committed-version identifier, (iv) a new committed-version identifier, (v) a cryptographic commitment over the new rule-set contents, and (vi) the authorized-update signature.

Upon receipt within the hardware trusted execution environment 110, the update record is verified against the committed governance root certificate. Upon successful verification, the new rule set is sealed under the new committed-version identifier, the prior committed-version identifier is retained in the sealed store to support subsequent rollback, and an attested update-acknowledgment record is produced by the attestation module 170 and committed to the tamper-evident methodology ledger 180. Upon failed verification, the update record is rejected and an attested governance-failure exception record is produced. The committed-version identifier of each rule set and methodology in force during any compliance computation is bound to the compliance attestation record for that computation, such that any relying party verifying a historical compliance attestation record can deterministically identify the rule-set and methodology versions applied at the time of production. This arrangement supports auditable rule-set governance without compromising the cryptographic integrity of historical compliance attestation records produced under prior rule-set versions.

### Commercial Use Cases

The platform 100 supports a plurality of institutional use cases, including without limitation those set forth in the following paragraphs. Each use case is illustrative and is not intended to limit the scope of the claims appended hereto.

Banks. A globally systemically important bank or other prudentially regulated bank operating a trading desk with exposure to prediction market contracts may use the platform 100 to produce, for each position or position change, a compliance attestation record satisfying the bank's internal capital adequacy assessment process and home-country comprehensive capital analysis documentation requirements. The compliance attestation record evidences the applied Standardized Approach for Counterparty Credit Risk methodology, the committed supervisory factor table version, the committed alpha multiplier, the committed netting determination, and the screening disposition for each counterparty. The bank's prudential supervisor independently verifies the compliance attestation record against the hardware-vendor attestation service without reliance on representations of the exchange operator or of the bank's compliance staff.

Broker-dealers. A broker-dealer subject to Securities Exchange Act Rule 15c3-1 and equivalent net capital rules may use the platform 100 to produce wrapped instrument definitions, capital treatment attributes, and compliance attestation records suitable for inclusion in the broker-dealer's net-capital documentation. Where the committed jurisdictional rule set classifies the wrapped derivative instrument as a security under the Securities Exchange Act of 1934, the reporting transformation module 160 produces reporting records configured to support submission under applicable broker-dealer reporting requirements promulgated under said Act.

Hedge funds. A hedge fund or proprietary trading firm holding directional or market-making positions in prediction market contracts may use the platform 100 to produce attested documentation supporting institutional counterparty diligence, including prime-broker counterparty diligence, fund-administrator valuation processes, and limited-partner reporting. The compliance attestation record supports investor diligence without disclosure of underlying participant identities, including through use of the optional zero-knowledge proof of the privacy-preserving extensions described herein, where deployed.

Asset managers. An asset manager subject to the Investment Advisers Act of 1940 or to applicable foreign prudential supervision may use the platform 100 to produce, for each managed-account position in a wrapped prediction market instrument, a compliance attestation record satisfying the asset manager's fiduciary documentation requirements and supporting beneficial-owner reporting where applicable.

Clearinghouses. A derivatives clearinghouse operating under designation as a Derivatives Clearing Organization or equivalent foreign clearinghouse designation may use the platform 100 to produce attested capital treatment and reporting records for cleared wrapped prediction market instruments, supporting the clearinghouse's margin documentation and default-management procedures with cryptographic evidence of the applied methodology versions.

Central banks. A central bank treasury operations function may use the platform 100 to produce attested documentation supporting incorporation of wrapped prediction market instrument positions into financial stability assessments, monetary policy preparation materials, and reserve management operations, with cryptographic evidence of compliance methodology that meets the central bank's internal model validation standards.

Sovereign wealth funds. A sovereign wealth fund subject to internal governance requirements regarding instrument eligibility, counterparty diligence, and reporting may use the platform 100 to produce compliance attestation records sufficient to satisfy the fund's sovereign oversight requirements with respect to wrapped prediction market instrument positions, including without limitation evidence of jurisdictional eligibility, capital treatment, and counterparty screening.

### Rollback and Recovery

The platform 100 supports rollback of committed rule sets and methodologies to a prior committed-version identifier upon receipt within the hardware trusted execution environment 110 of an attested rollback record signed by an authorized rollback key whose certificate chains to the governance root certificate committed at system initialization. The attested rollback record comprises (i) a target prior committed-version identifier, (ii) a rollback timestamp, (iii) an authorized rollback signature, and (iv) a rollback rationale identifier. Upon successful verification, the targeted committed-version identifier is restored to the sealed store, an attested rollback-acknowledgment record is produced by the attestation module 170 and committed to the tamper-evident methodology ledger 180, and subsequent compliance computations are produced under the restored committed-version identifier. The historical chain of compliance attestation records produced under intervening committed-version identifiers remains intact and is not modified or removed; the rollback affects only the operative committed-version identifier going forward.

Where a defective update to a committed rule set has been detected through downstream verification, the attested governance channel additionally supports issuance of a corrective update record introducing a new committed-version identifier that supersedes the defective intervening version, with both the rollback record and the corrective update record committed to the tamper-evident methodology ledger 180 to preserve the full audit trail of the update history. This arrangement enables remediation of defective updates with cryptographic preservation of the full update-rollback history.

### Algorithm Transition

The platform 100 supports transition from a predecessor cryptographic algorithm to a successor cryptographic algorithm through the following concrete steps performed within the hardware trusted execution environment 110: (i) generating a successor key under the successor cryptographic algorithm identifier within the hardware boundary of the hardware trusted execution environment 110; (ii) sealing the successor key to the hardware identity of the hardware trusted execution environment 110; (iii) producing a transition attestation record comprising the predecessor cryptographic algorithm identifier, the successor cryptographic algorithm identifier, the timestamp of transition, and a transition rationale identifier, the transition attestation record being signed under both the predecessor cryptographic algorithm identifier and the successor cryptographic algorithm identifier; (iv) committing the transition attestation record to the tamper-evident methodology ledger 180; and (v) preserving a chain of cryptographic hash references from compliance attestation records produced under the predecessor cryptographic algorithm identifier to compliance attestation records produced under the successor cryptographic algorithm identifier, such that a relying party can traverse the chain to verify the algorithm-transition history.

Successor cryptographic algorithms supported by the platform 100 include, without limitation, post-quantum signature schemes standardized by the United States National Institute of Standards and Technology under Federal Information Processing Standard 204 and post-quantum key-encapsulation schemes standardized under Federal Information Processing Standard 203, as well as classical signature schemes implementing Edwards-curve Digital Signature Algorithm and Elliptic Curve Digital Signature Algorithm under successor curve identifiers.

### Enablement Example 1

By way of non-limiting enablement example, a globally systemically important bank trading desk seeks to acquire a position in a wrapped binary event contract derived from a native prediction market contract listed on an intermediated Designated Contract Market. The native contract specifies a binary payout contingent on the occurrence of a specified macroeconomic event with a settlement date nine months (0.75 years) from acquisition. The trading desk submits the acquisition request through its institutional order management system to the platform 100. Native data intake interface 115 delivers the native contract specification, the position record (notional $1,000,000; direction long; price 0.27), and the trading desk's participant-identity record (pseudonymized identifier derived from a cryptographic hash of the bank's know-your-customer attestation data on file with the intermediating futures-commission-merchant) over an encrypted channel terminating at an endpoint within the hardware trusted execution environment 110.

Screening module 130 retrieves the committed rule set (version 2026.04.RC1) sealed to the hardware identity. The participant-identity record produces a watchlist match score of zero; the linkage fingerprint received via the companion hardware-attested trade integrity system through the companion-integration interface 125 indicates magnitude 0.03 with no high-risk linkage; the know-your-customer attestation verification predicate evaluates true. With committed parameters α=0.40, β=0.50, γ=0.10, and δ=0.20, the composite risk score evaluates to 0.50·0.03=0.015, below the soft-flag threshold of 0.10 committed in the rule set. The screening module 130 produces a screened record with disposition indicator pass.

Jurisdictional mapping module 140 selects the committed jurisdictional rule set for intermediated Designated Contract Markets under Commodity Exchange Act Section 5 (version 2026.04.JR2). The eligibility determination evaluates true. The priority-ordered decision tree classifies the contract as a binary option under contract type=BINARY_OPTION and treatment_class=FUTURES_STYLE. The module 140 produces a wrapped instrument definition with notional $1,000,000, maturity 0.75 years (nine months), settlement type CASH, settlement mechanism EXCHANGE-CALCULATED, margin requirements per the committed rule set, reporting_schema_identifier=CFTC_PART_16, and companion_system_references comprising the attestation quote identifier of the consumed trade-integrity record.

Capital treatment mapping module 150 retrieves the committed supervisory factor table (version 2026.04.SF1) and the committed capital mapping methodology (version 2026.04.CM3). With asset_class=OTHER and supervisory factor sf=0.18; current market value $15,000; collateral $0; alpha multiplier α=1.4; maturity factor MF=min(1.0, √(min(0.75, 1.0)/1.0))≈0.866; aggregate add-on=$1,000,000·0.18·0.866≈$155,880; potential future exposure PFE=$155,880; replacement cost RC=max($15,000−$0, 0)=$15,000; exposure at default EAD=1.4·($15,000+$155,880)≈$239,232. The committed methodology versions, the committed alpha multiplier, and the no-netting determination are committed to the compliance attestation record. The verified prediction confidence scoring system has delivered a probability record indicating no insider-risk indicator above the configured z-score threshold; no risk adjustment is applied.

Reporting transformation module 160 generates a reporting record configured for submission under 17 C.F.R. Part 16, comprising trade and volume fields populated by the committed reporting schema mapping (version 2026.04.RS1) from the wrapped instrument definition. The validity predicate of each field evaluates true. The schema-transformation log is committed to the compliance attestation record. Attestation module 170 produces a compliance attestation record (record identifier RCW-2026-04-23-00001) binding the hardware measurement register value, the input commitments, the rule-set and methodology commitments enumerated above, the wrapped instrument definition, the capital treatment attributes, and the reporting record, with a signature produced using the hardware-rooted attestation key. The record is admitted to the institutional export interface 190 upon satisfaction of the dual-gating condition. The bank's prudential supervisor verifies the compliance attestation record against the hardware-vendor attestation service of the hardware vendor without participation of the exchange operator.

### Enablement Example 2

By way of further non-limiting enablement example, a sovereign wealth fund seeks to acquire a position in a wrapped categorical event contract derived from a native prediction market contract listed on an intermediated Designated Contract Market and economically equivalent to a contract listed on a foreign regulated venue subject to equivalent foreign prudential supervision. The native contract specifies a categorical payout over four mutually exclusive outcomes contingent on the resolution of a specified geopolitical event with a settlement date six months (0.5 years) from acquisition. The fund submits the acquisition request through its portfolio management system to the platform 100, configured for dual-jurisdiction wrapping. Native data intake interface 115 delivers the native contract specification, the position record (notional $5,000,000; direction long on outcome A; price 0.42), and the fund's participant-identity record over an encrypted channel terminating at an endpoint within the hardware trusted execution environment 110.

Screening module 130 retrieves the committed rule set (version 2026.04.RC1) and the committed sanctions list (version 2026.04.SL2). The participant-identity record produces a watchlist match score of zero; the linkage fingerprint indicates magnitude 0.07; the know-your-customer attestation verification predicate evaluates true. With committed parameters α=0.40, β=0.50, γ=0.10, and δ=0.20, the composite risk score evaluates to 0.50·0.07=0.035, below the soft-flag threshold of 0.10. The disposition indicator evaluates to pass.

Jurisdictional mapping module 140 produces two wrapped instrument definitions: a primary wrapped instrument definition under the committed jurisdictional rule set for intermediated Designated Contract Markets (contract_type=CATEGORICAL; treatment_class=SWAP_STYLE) with reporting_schema_identifier=CFTC_PART_45; and a secondary wrapped instrument definition under the committed foreign-regulatory rule set (contract type=CATEGORICAL; treatment_class per the committed foreign rule set) with the applicable foreign reporting_schema_identifier. The two wrapped instrument definitions are bound by attested cross-references.

Capital treatment mapping module 150 computes, for the primary wrapped instrument definition: asset_class=OTHER; sf=0.18; current market value $42,000 (mark-to-market gain of $42,000 on $5,000,000 notional at price 0.42 versus 0.41 reference); collateral $0; α=1.4; maturity factor MF=min(1.0, √(min(0.5, 1.0)/1.0)) 0.707; aggregate add-on=$5,000,000·0.18·0.707≈$636,300; PFE=$636,300; RC=$42,000; EAD=1.4·($42,000+$636,300)≈$949,620. The verified prediction confidence scoring system has delivered an insider-risk indicator of 0.05 computed at the configured z-score threshold, accompanied by a verified companion attestation quote. With committed parameter δ=0.20 and committed cap 0.30 (i.e., 30% maximum adjustment), the adjusted exposure at default EAD′=$949,620·(1+0.20·0.05)=$949,620·1.01=$959,116.

Reporting transformation module 160 generates: a primary reporting record configured for submission under 17 C.F.R. Part 45 to a Commodity Futures Trading Commission-designated Swap Data Repository; and a secondary reporting record configured for submission under the applicable foreign regulatory schema. Each reporting record is accompanied by a hardware-attestation quote binding the reporting record to the compliance attestation record. Attestation module 170 produces a compliance attestation record (record identifier RCW-2026-04-23-00002) binding both wrapped instrument definitions, their capital treatment attributes (including the verified-prediction-confidence-derived risk adjustment), the reporting records, the schema-transformation log, the input commitments, and the rule-set and methodology commitments. The record is admitted to the institutional export interface 190 upon satisfaction of the dual-gating condition. The fund's sovereign oversight body and the supervisor of the foreign regulated venue each verify the compliance attestation record against the hardware-vendor attestation service of the common hardware vendor.

### Enablement Example 3

By way of further non-limiting enablement example, the platform 100 is operated through a transition from a predecessor cryptographic algorithm to a successor cryptographic algorithm. The predecessor cryptographic algorithm is Elliptic Curve Digital Signature Algorithm operating over the National Institute of Standards and Technology P-256 curve (predecessor cryptographic algorithm identifier ECDSA-P256-SHA256). The successor cryptographic algorithm is Module-Lattice-Based Digital Signature Algorithm at security category 2 standardized under Federal Information Processing Standard 204 (successor cryptographic algorithm identifier ML-DSA-44).

An attested transition record is delivered to the hardware trusted execution environment 110 over the attested governance channel. The attested transition record comprises: predecessor cryptographic algorithm identifier=ECDSA-P256-SHA256; successor cryptographic algorithm identifier=ML-DSA-44; transition timestamp=2027-01-15T00:00:00Z; transition rationale identifier=POST_QUANTUM_TRANSITION_FIPS204; and a governance signature produced using an authorized governance key whose certificate chains to the governance root certificate committed at system initialization. The hardware trusted execution environment 110 verifies the attested transition record against the committed governance root certificate.

Upon successful verification, the hardware trusted execution environment 110 generates a successor key under ML-DSA-44 within the hardware boundary, seals the successor key to the hardware identity, and produces a transition attestation record (record identifier TX-2027-01-15-00001) signed under both the predecessor cryptographic algorithm (ECDSA-P256-SHA256 signature over the transition fields) and the successor cryptographic algorithm (ML-DSA-44 signature over the same transition fields). The transition attestation record is committed to the tamper-evident methodology ledger 180. Subsequent compliance attestation records produced by the platform 100 are signed under ML-DSA-44 and incorporate a cryptographic hash reference to the transition attestation record, establishing a verifiable chain from compliance attestation records produced under ECDSA-P256-SHA256 prior to the transition to compliance attestation records produced under ML-DSA-44 after the transition. A relying party verifying a post-transition compliance attestation record traverses the cryptographic hash reference to the transition attestation record, verifies both the predecessor and successor signatures on the transition attestation record, and thereby confirms the algorithm-transition history of the platform 100 without intermediation by the platform operator or any other party.

### Advantages of the Invention

The platform of the present invention provides, in one or more embodiments, the following objective technical advantages over prior categories of compliance and confidential-computing infrastructure: (i) cryptographic third-party verifiability of compliance output integrity, rule-set integrity, and input-record integrity, achieved without intermediation by representations of the exchange operator or by software-audit-firm certifications; (ii) unified attestation across the screening, mapping, capital, reporting, and attestation pipeline, achieved through a single hardware-rooted boundary in lieu of distributed software components; (iii) auditable rule-set governance, achieved through hardware-sealed storage of committed rule sets, attested governance updates, and a tamper-evident methodology ledger; (iv) preservation of the cryptographic integrity of historical compliance attestation records under rule-set updates and algorithm transitions, achieved through hash-chained transition records; (v) cryptographic isolation between tenants on shared hardware, achieved through per-tenant hardware identities and per-tenant sealed stores; (vi) selective disclosure of compliance evidence consistent with applicable privacy law, achieved through optional zero-knowledge proof accompaniment of the compliance attestation record; (vii) recovery from defective rule-set updates with full audit trail preservation, achieved through the attested rollback record and corrective update record arrangement; and (viii) cross-vendor portability through trusted-execution-environment-vendor-agnostic deployment, achieved through the multi-vendor embodiments recited in this specification.

### ALTERNATIVES AND SCOPE

The embodiments described herein are illustrative and are not intended to limit the scope of the invention. Alternative embodiments include, without limitation: machine-learning-assisted screening using classifiers trained on labeled enforcement histories in place of or in addition to rule-based screening; dynamic rule-set updates delivered through attested governance channels whose update authority is itself hardware-attested; leverage-adjusted and margin-sensitive capital mappings for wrapped instruments traded on margin; extensions to foreign regulatory schemas; application to event-linked derivatives outside the prediction market context, including parametric insurance contracts, weather derivatives, and event-contingent swaps traded on registered swap execution facilities; and extension of the integrated multi-system hardware-attested architecture described above to additional compliance subsystems addressing market abuse, best execution, and transaction cost analysis. Features from different embodiments may be combined. Numerical thresholds and specific algorithms are exemplary; the full scope extends to equivalents.

Further alternative embodiments include privacy-preserving variants in which differential-privacy noise calibrated to a configured privacy budget is applied to aggregate compliance outputs prior to export, with the noise parameters themselves committed to the compliance attestation record; secure multi-party computation variants in which cross-institution compliance processing is performed using hardware-trusted-execution-environment-anchored participants such that no single institutional counterparty observes the complete compliance record of positions held by another institutional counterparty; and multi-tenant deployments in which a plurality of tenant-specific hardware trusted execution environments operate on a common hardware platform, each with a distinct hardware identity and distinct sealed store, with cryptographic isolation of tenant-specific compliance attestation records.

The terms “engine,” “module,” “layer,” “attestor,” “prover,” “authority,” “controller,” “interface,” “orchestration layer,” “generator,” “vault,” and “pool” as used herein are not intended to invoke 35 U.S.C. § 112(f). Each such term denotes a class of computational structure described herein with sufficient specificity—including the algorithms, data structures, attested measurements, and cryptographic signatures recited in the corresponding sections of the Detailed Description—to identify the corresponding structure to a person of ordinary skill in the art.

While certain embodiments described herein reference specific regulatory frameworks, including without limitation Commodity Futures Trading Commission regulations at 17 C.F.R. Parts 16, 17, and 45, the Standardized Approach for Counterparty Credit Risk, Securities Exchange Act Rule 15c3-1, and the Bank Secrecy Act, these references are illustrative and the platform of the present invention is configured to operate under any committed jurisdictional rule set, committed capital mapping methodology, and committed reporting schema mapping sealed to the hardware identity of the hardware trusted execution environment. The platform is not limited to embodiments operating under any particular regulatory structure, nor to any particular version of any regulation, statute, supervisory guidance, or international standard cited herein, nor to any future amendment, replacement, repeal, or successor framework thereto; the architectural relationships among the hardware trusted execution environment, the measured compliance code base, the committed rule sets and methodologies, the wrapped instrument definition, the compliance attestation record, the four-element interlock, and the dual-gating condition are independent of the specific content of any rule set or methodology committed at a particular time.

No statement in this specification is intended to disclaim any specific embodiment from the scope of the claims appended hereto, and no admission is made that any reference, system, methodology, regulatory framework, technology category, or product described in the Background section or referenced elsewhere herein constitutes prior art against the claims. Characterizations of existing categories of compliance software, exchange reporting systems, and confidential-computing infrastructure are provided herein for technical comparison only. References herein to specific products, vendors, standards bodies, or technologies are provided solely to identify representative non-limiting embodiments and are not intended to limit the scope of the claims to those specific products, vendors, standards, or technologies.

What is claimed is:

1. A hardware-attested wrapper system for transforming a native prediction market contract into a wrapped derivative instrument, the system comprising:
(a) a hardware trusted execution environment having a hardware measurement register and a hardware-rooted attestation key provisioned by a hardware vendor, the hardware trusted execution environment configured to load a measured compliance code base upon instantiation;
(b) a compliance processing engine executing within the hardware trusted execution environment and configured to (i) apply a committed rule set to a participant-identity record received over an encrypted channel terminating within the hardware trusted execution environment to produce a screened record having a disposition indicator, (ii) transform the native prediction market contract into a wrapped instrument definition under a committed jurisdictional rule set when the disposition indicator does not indicate hard-block, (iii) assign capital treatment attributes to the wrapped instrument definition under a committed capital mapping methodology, (iv) generate a regulatory reporting record from the wrapped instrument definition under a committed reporting schema mapping, and (v) produce a compliance attestation record; and
(c) an export interface configured to deliver the wrapped instrument definition, the capital treatment attributes, the regulatory reporting record, and the compliance attestation record to an external relying party in a form independently verifiable against a hardware-vendor attestation service of the hardware vendor;
wherein the compliance processing engine operates under a four-element interlock comprising:
first, cryptographic binding of the hardware measurement register to the measured compliance code base loaded upon instantiation;
second, sealing of each of the committed rule set, the committed jurisdictional rule set, the committed capital mapping methodology, and the committed reporting schema mapping to a hardware identity of the hardware trusted execution environment;
third, binding of the wrapped instrument definition, the capital treatment attributes, and the regulatory reporting record to version identifiers of the committed rule set, the committed jurisdictional rule set, the committed capital mapping methodology, and the committed reporting schema mapping each as in force during a computation interval; and
fourth, cryptographic binding, within the compliance attestation record, of (1) the hardware measurement register, (2) a cryptographic commitment over the native prediction market contract and the participant-identity record, (3) cryptographic commitments over the committed rule set, the committed jurisdictional rule set, the committed capital mapping methodology, and the committed reporting schema mapping, and (4) the wrapped instrument definition, the capital treatment attributes, and the regulatory reporting record; and
wherein the compliance attestation record is admitted to the export interface only upon satisfaction of a dual-gating condition comprising (i) a match between the hardware measurement register and an authorized-measurement set committed at system initialization, and (ii) production of a signature over the compliance attestation record using the hardware-rooted attestation key within the hardware trusted execution environment.

2. A method of producing a hardware-attested wrapped prediction market instrument, the method comprising:
loading a measured compliance code base into a hardware trusted execution environment having a hardware measurement register and a hardware-rooted attestation key provisioned by a hardware vendor;
receiving, over an encrypted channel terminating within the hardware trusted execution environment, a native prediction market contract specification and a participant-identity record;
applying, within the hardware trusted execution environment, a committed rule set sealed to a hardware identity of the hardware trusted execution environment to the participant-identity record to produce a screened record having a disposition indicator;
when the disposition indicator indicates hard-block, rejecting production of a wrapped instrument definition and producing an attested exception record signed using the hardware-rooted attestation key;
when the disposition indicator indicates pass, producing within the hardware trusted execution environment a wrapped instrument definition under a committed jurisdictional rule set sealed to the hardware identity, capital treatment attributes under a committed capital mapping methodology sealed to the hardware identity, a regulatory reporting record under a committed reporting schema mapping sealed to the hardware identity, and a compliance attestation record; and
exporting, in a form independently verifiable against a hardware-vendor attestation service of the hardware vendor, the wrapped instrument definition, the capital treatment attributes, the regulatory reporting record, and the compliance attestation record;
wherein the method operates under a four-element interlock comprising (i) cryptographic binding of the hardware measurement register to the measured compliance code base upon instantiation; (ii) sealing of each of the committed rule set, the committed jurisdictional rule set, the committed capital mapping methodology, and the committed reporting schema mapping to the hardware identity; (iii) binding of the wrapped instrument definition, the capital treatment attributes, and the regulatory reporting record to version identifiers of the committed rule set, the committed jurisdictional rule set, the committed capital mapping methodology, and the committed reporting schema mapping each as in force during the producing step; and (iv) cryptographic binding, within the compliance attestation record, of the hardware measurement register, a cryptographic commitment over the received native prediction market contract specification and the received participant-identity record, cryptographic commitments over the committed rule set, the committed jurisdictional rule set, the committed capital mapping methodology, and the committed reporting schema mapping, and the wrapped instrument definition, the capital treatment attributes, and the regulatory reporting record; and
wherein the compliance attestation record is admitted to the exporting step only upon satisfaction of a dual-gating condition comprising (i) a match between the hardware measurement register and an authorized-measurement set committed at system initialization, and (ii) production of a signature over the compliance attestation record using the hardware-rooted attestation key within the hardware trusted execution environment.

3. A non-transitory computer-readable medium storing program instructions that, when executed within a hardware trusted execution environment of a computer system, cause the hardware trusted execution environment to perform operations comprising:
loading a measured compliance code base such that a hardware measurement register of the hardware trusted execution environment cryptographically binds to the loaded measured compliance code base upon instantiation;
receiving, over an encrypted channel terminating within the hardware trusted execution environment, a native prediction market contract specification and a participant-identity record;
applying a committed rule set sealed to a hardware identity of the hardware trusted execution environment to the participant-identity record to produce a screened record having a disposition indicator;
producing, in dependence on the disposition indicator, a wrapped instrument definition under a committed jurisdictional rule set sealed to the hardware identity, capital treatment attributes under a committed capital mapping methodology sealed to the hardware identity, a regulatory reporting record under a committed reporting schema mapping sealed to the hardware identity, and a compliance attestation record cryptographically signed using a hardware-rooted attestation key of the hardware trusted execution environment; and
exporting, in a form independently verifiable against a hardware-vendor attestation service of a hardware vendor of the hardware trusted execution environment, the wrapped instrument definition, the capital treatment attributes, the regulatory reporting record, and the compliance attestation record;
wherein the operations are performed under a four-element interlock comprising (i) cryptographic binding of the hardware measurement register to the loaded measured compliance code base; (ii) sealing of each of the committed rule set, the committed jurisdictional rule set, the committed capital mapping methodology, and the committed reporting schema mapping to the hardware identity; (iii) binding of the wrapped instrument definition, the capital treatment attributes, and the regulatory reporting record to version identifiers of the committed rule set, the committed jurisdictional rule set, the committed capital mapping methodology, and the committed reporting schema mapping in force; and (iv) cryptographic binding, within the compliance attestation record, of the hardware measurement register, a cryptographic commitment over the received native prediction market contract specification and the received participant-identity record, cryptographic commitments over the committed rule set, the committed jurisdictional rule set, the committed capital mapping methodology, and the committed reporting schema mapping, and the wrapped instrument definition, the capital treatment attributes, and the regulatory reporting record; and
wherein the compliance attestation record is admitted to the exporting operation only upon satisfaction of a dual-gating condition comprising (i) a match between the hardware measurement register and an authorized-measurement set committed at system initialization, and (ii) production of a signature over the compliance attestation record using the hardware-rooted attestation key within the hardware trusted execution environment.

4. The system of claim 1, wherein the wrapped instrument definition is represented as a versioned data structure stored within memory accessible to the hardware trusted execution environment, the versioned data structure conforming to a canonical wrapped-instrument schema comprising at least the following fields: source identifiers comprising a source exchange identifier and a source contract identifier; regulatory-designation attributes comprising a jurisdiction identifier, a regulatory designation, and a jurisdictional rule-set version identifier; contract-classification attributes comprising a contract type and a treatment class drawn from committed enumerations; economic attributes comprising a notional amount with a currency code, a maturity, a settlement type, and a settlement mechanism; institutional-treatment attributes comprising margin requirements, position limits, and a capital-methodology identifier; reporting attributes comprising a reporting-schema identifier; companion-system references comprising a companion attestation quote identifier of each attested input received by the compliance processing engine; and attestation commitments comprising cryptographic commitments over received inputs, the committed rule set, the committed jurisdictional rule set, the committed capital mapping methodology, and the committed reporting schema mapping in force, the versioned data structure being identified by a wrapper-schema version identifier committed to the compliance attestation record.

5. The system of claim 1, wherein each compliance attestation record produced by the compliance processing engine conforms to a canonical, versioned compliance-attestation schema comprising: a hardware measurement register value produced upon instantiation of the measured compliance code base; a hardware-vendor-signed chain-of-trust certificate bound to the hardware identity of the hardware trusted execution environment; a cryptographic commitment over the native prediction market contract, the participant-identity record, and a position record received within the computation interval; cryptographic commitments over a committed rule-set version identifier, a committed jurisdictional rule-set version identifier, a committed supervisory factor table version identifier, a committed alpha multiplier, a committed netting determination, and a committed reporting schema mapping version identifier; the wrapped instrument definition, the assigned capital treatment attributes, and the generated regulatory reporting record; a companion attestation quote identifier of each attested input received by the compliance processing engine during the computation interval; and a signature over the foregoing fields produced using the hardware-rooted attestation key.

6. The system of claim 1, wherein the compliance processing engine is further configured, upon detection of an exception condition selected from at least a mapping-ambiguity condition, a screening-hard-block condition, an eligibility-rejection condition, a capital-methodology-unavailable condition, a reporting-schema-mismatch condition, a companion-system-attestation-failure condition, and an attestation-failure condition, to halt production of the wrapped instrument definition where the exception condition is the mapping-ambiguity condition, the screening-hard-block condition, the eligibility-rejection condition, the companion-system-attestation-failure condition, or the attestation-failure condition, and to produce an attested exception record comprising an exception-category identifier, an exception timestamp, an upstream processing state, and a cryptographic commitment over affected inputs, the attested exception record being signed using the hardware-rooted attestation key and committed to a tamper-evident methodology ledger configured to receive only writes signed using the hardware-rooted attestation key.

7. The system of claim 1, wherein in a screening-only mode of operation the compliance processing engine omits production of the wrapped instrument definition, the capital treatment attributes, and the regulatory reporting record, and instead produces a screening attestation record comprising (i) the screened record, (ii) the hardware measurement register, (iii) a cryptographic commitment over the participant-identity record, and (iv) a cryptographic commitment over a version identifier of the committed rule set in force, the screening attestation record being signed using the hardware-rooted attestation key and admitted to the export interface only upon satisfaction of the dual-gating condition.

8. The system of claim 1, wherein the committed jurisdictional rule set comprises a rule set for at least one of (i) a Designated Contract Market under the Commodity Exchange Act, (ii) an intermediated Designated Contract Market permitting futures-commission-merchant intermediation, and (iii) a securities exchange registered under the Securities Exchange Act of 1934, and wherein the committed reporting schema mapping is configured to support submission of the regulatory reporting record under at least one of 17 C.F.R. Part 16, 17 C.F.R. Part 17, and 17 C.F.R. Part 45 in dependence on the wrapped instrument definition.

9. The system of claim 1, wherein in a capital-treatment-only mode of operation the compliance processing engine omits production of the regulatory reporting record, and instead produces a capital-treatment attestation record comprising (i) the capital treatment attributes, (ii) the hardware measurement register, (iii) a cryptographic commitment over the wrapped instrument definition, and (iv) a cryptographic commitment over a version identifier of the committed capital mapping methodology in force, wherein the committed capital mapping methodology comprises the Standardized Approach for Counterparty Credit Risk and a committed supervisory factor table, and wherein the capital-treatment attestation record is signed using the hardware-rooted attestation key and admitted to the export interface only upon satisfaction of the dual-gating condition.

10. The system of claim 1, wherein in a reporting-only mode of operation the compliance processing engine omits production of the capital treatment attributes, and instead produces a reporting attestation record comprising (i) the regulatory reporting record, (ii) the hardware measurement register, (iii) a cryptographic commitment over the wrapped instrument definition, and (iv) a cryptographic commitment over a version identifier of the committed reporting schema mapping in force, the reporting attestation record being signed using the hardware-rooted attestation key and admitted to the export interface only upon satisfaction of the dual-gating condition.

11. The system of claim 1, wherein the hardware trusted execution environment comprises at least one of Intel Trust Domain Extensions, Intel Software Guard Extensions, Advanced Micro Devices Secure Encrypted Virtualization with Secure Nested Paging, Advanced Reduced Instruction Set Computer Machines Confidential Compute Architecture, and IBM Secure Execution for Linux, and wherein the hardware measurement register and the hardware-rooted attestation key are provided by the hardware trusted execution environment.

12. The method of claim 2, further comprising, upon receipt of an attested transition record within the hardware trusted execution environment, the attested transition record comprising a predecessor cryptographic algorithm identifier, a successor cryptographic algorithm identifier, a transition timestamp, and a signature produced using a governance key whose certificate chains to a governance root certificate committed at system initialization: generating a successor key under the successor cryptographic algorithm identifier within the hardware trusted execution environment; sealing the generated successor key to the hardware identity of the hardware trusted execution environment; producing a transition attestation record signed under both the predecessor cryptographic algorithm identifier and the successor cryptographic algorithm identifier; committing the transition attestation record to a tamper-evident methodology ledger; and preserving a chain of cryptographic hash references from compliance attestation records produced under the predecessor cryptographic algorithm identifier to compliance attestation records produced under the successor cryptographic algorithm identifier.

13. The method of claim 2, further comprising, upon receipt of an attested rollback record within the hardware trusted execution environment, the attested rollback record comprising a target prior committed-version identifier, a rollback timestamp, and a signature produced using an authorized rollback key whose certificate chains to a governance root certificate committed at system initialization: verifying the attested rollback record against the governance root certificate; restoring the committed rule set, the committed jurisdictional rule set, the committed capital mapping methodology, and the committed reporting schema mapping each to the target prior committed-version identifier; producing a rollback-acknowledgment attestation record signed using the hardware-rooted attestation key and committing the rollback-acknowledgment attestation record to a tamper-evident methodology ledger; and continuing production of subsequent compliance attestation records under the restored committed-version identifier.

14. The method of claim 2, further comprising, upon receipt within the hardware trusted execution environment of an attested update record comprising an updating-authority identifier, an update timestamp, a prior committed-version identifier, a new committed-version identifier, a cryptographic commitment over a new rule-set or methodology, and an authorized-update signature: verifying the attested update record against a governance root certificate committed at system initialization; sealing the new rule-set or methodology under the new committed-version identifier to the hardware identity; retaining the prior committed-version identifier in sealed storage; producing an update-acknowledgment attestation record signed using the hardware-rooted attestation key; and committing the update-acknowledgment attestation record to a tamper-evident methodology ledger configured to receive only writes signed using the hardware-rooted attestation key, wherein the committed-version identifier in force during a subsequent compliance computation is bound to the compliance attestation record for that compliance computation.

15. The method of claim 2, wherein the producing of the regulatory reporting record produces, in dependence on the wrapped instrument definition, a reporting record formatted for delivery configured to support submission under at least one of: (i) 17 C.F.R. Part 16, when the wrapped instrument definition classifies the wrapped derivative instrument as a contract traded on a Designated Contract Market under the Commodity Exchange Act; (ii) 17 C.F.R. Part 17, when a position size associated with the wrapped instrument definition exceeds a large-trader threshold identified in the committed reporting schema mapping; and (iii) 17 C.F.R. Part 45, when the wrapped instrument definition classifies the wrapped derivative instrument as a swap under the committed jurisdictional rule set, with delivery configured for a Commodity Futures Trading Commission-designated Swap Data Repository; the method further comprising emitting, together with each such reporting record, a hardware-attestation quote binding the reporting record to the compliance attestation record and to a committed reporting schema mapping version identifier.

16. The system of claim 1, wherein the native prediction market contract comprises at least one of: a binary option contract resolving to one of two outcomes; a categorical event contract resolving to one of three or more mutually exclusive outcomes; a scalar outcome contract whose payout is a function of a continuous-valued outcome variable; a hybrid contract combining at least two of categorical and scalar payout structures; and an event-contingent derivative contract whose payout is contingent on the occurrence or non-occurrence of a specified event; and wherein the wrapped instrument definition records a contract type identifier identifying the type of the native prediction market contract together with the associated treatment class assigned by the committed jurisdictional rule set in force during a computation interval.

17. The system of claim 1, further comprising a companion-integration interface configured to receive over channels terminating within the hardware trusted execution environment (i) an attested trade-integrity record from a companion hardware-attested trade integrity system, the attested trade-integrity record comprising an account-linkage fingerprint, a cross-account coordination score, and a first companion attestation quote identifier, and (ii) an attested probability record from a companion verified prediction confidence scoring system, the attested probability record comprising a signal-weighted probability, a calibrated probability, an insider-risk indicator, and a second companion attestation quote identifier; wherein the compliance processing engine is configured to incorporate the account-linkage fingerprint and the cross-account coordination score into a composite risk score used to determine the disposition indicator; wherein the compliance processing engine is configured to apply a risk adjustment to the capital treatment attributes as a function of the insider-risk indicator and a committed risk-adjustment parameter; and wherein the first companion attestation quote identifier and the second companion attestation quote identifier are committed to the compliance attestation record.

18. The non-transitory computer-readable medium of claim 3, wherein the operations further comprise generating, together with the compliance attestation record, a zero-knowledge proof attesting that the wrapped instrument definition was produced by the committed jurisdictional rule set on a participant-identity record consistent with an external commitment and on a position record consistent with an external commitment, without disclosing participant-level data or an individual position size to a recipient, and wherein in a zero-knowledge-only mode of operation the operations export the zero-knowledge proof and the compliance attestation record without exporting the participant-identity record or any individual position size.

19. The system of claim 1, wherein the wrapped instrument definition is represented as a versioned data structure whose field-level schema is committed to the compliance attestation record through a wrapper-schema version identifier, and wherein the wrapped instrument definition, the capital treatment attributes, and the regulatory reporting record are configured to support institutional balance-sheet recognition of the wrapped derivative instrument and submission of the regulatory reporting record to an external relying party, recognition and submission by the external relying party being conditioned on independent verification of the compliance attestation record against the hardware-vendor attestation service of the hardware vendor, such that the wrapped derivative instrument represented by the wrapped instrument definition data structure carries cryptographic bindings to the committed jurisdictional rule set version, the committed capital mapping methodology version, the committed reporting schema mapping version, the measured compliance code base, and the hardware measurement register sufficient for the institutional balance-sheet recognition and the regulatory reporting submission.

20. The non-transitory computer-readable medium of claim 3, wherein the operations further comprise committing each compliance attestation record to a tamper-evident methodology ledger organized as a Merkle accumulator, the tamper-evident methodology ledger configured to receive only writes signed using the hardware-rooted attestation key, and periodically publishing a root of the Merkle accumulator to an external public commitment channel comprising at least one of a public blockchain, a regulator-operated commitment endpoint, and a consortium-operated commitment channel, wherein a relying party is enabled to verify temporal integrity of a past compliance attestation record by obtaining a Merkle inclusion proof from the tamper-evident methodology ledger and verifying said Merkle inclusion proof against a published root from the external public commitment channel.
